(19) United States
(12) Patent Application Publication
(10) Pub. No.: US 2024/0117141 A1
(43) Pub. Date: Apr. 11, 2024

(54) PROCESS FOR HYDRODEPOLYMERIZATION OF POLYMERIC WASTE MATERIAL

(71) Applicant: Basell Poliolefine Italia S.r.l., Milano (IT)

(72) Inventors: Shahram Mihan, Bad Soden (DE); Volker Fraaije, Frankfurt (DE)

(73) Assignee: Basell Poliolefine Italia S.r.l., Milano (IT)

(21) Appl. No.: 18/262,041

(22) PCT Filed: Jan. 20, 2022
(86) PCT No.: PCT/EP2022/051275

§ 371 Date: Jul. 19, 2023

(30) Foreign Application Priority Data
Jan. 21, 2021 (EP) 21152705.6

(51) Int. Cl. C08J 11/16; C10G 1/06; C10G 1/08; C10G 1/10

(52) U.S. Cl. CPC C08J 11/16; C10G 1/06; C10G 1/086; C10G 1/10; C08J 2323/16; C08J 2423/06; C08J 2423/12; C08J 2425/06; C08J 2431/08; C08J 2477/00; C10G 2300/1003; C10G 2400/20

(57) ABSTRACT

A process for the hydrodepolymerization of polymeric waste material at a hydrogen pressure from 20 to 500 bar, with a hydrocracking catalyst made from or containing (a) a hydrogenating component made from or containing a metal selected from the group consisting of Fe, Mo, W, Ti, Ni, Cr, V, Co, Zr, and mixtures thereof, supported on an inorganic carrier, and (b) a depolymerizing component being an acidic compound.

### FIELD OF THE DISCLOSURE

In general, the present disclosure relates to the field of chemistry. More specifically, the present disclosure relates to polymer chemistry. In particular, the present disclosure relates to a process for the hydrodepolymerization of polymeric waste material in the presence of a hydrocracking catalyst.

### BACKGROUND OF THE DISCLOSURE

Polymeric products, including plastics, are used in human life and result in waste plastics materials. In some instances, recycling manages waste plastics materials. In some instances, research is focusing on the pyrolysis to convert plastic waste into chemical intermediates.

In some instances, there is a focus on yield and energy efficiency.

### SUMMARY OF THE DISCLOSURE

In a general embodiment, the present disclosure provides a process for the hydrodepolymerization of polymeric waste material, including the steps of:
i) providing a feedstock of polymeric waste material;
ii) mixing the feedstock of polymeric waste material with a hydrocracking catalyst made from or containing
   a) a hydrogenating component made from or containing a metal selected from the group consisting of Fe, Mo, W, Ti, Ni, Cr, V, Co, Zr, and mixtures thereof, supported on an inorganic carrier and
   b) a depolymerizing component being an acidic compound;
iii) depolymerizing the mixture in the presence of hydrogen in a reactor at a hydrogen pressure from 20 to 500 bar, thereby yielding a reactor content made from or containing the hydrocracking catalyst, gaseous reaction products, and a hydrodepolymerization product;
iv) separating the content of the reactor, thereby obtaining a liquid or liquefiable hydrodepolymerization product, the hydrocracking catalyst, or hydrogen-enriched gas fractions;
v) optionally, re-introducing the hydrocracking catalyst or hydrogen-enriched gas fractions obtained in separation step iv) into the reactor; and
vi) optionally, collecting the hydrogen-enriched gas fractions.

In some embodiments, the depolymerizing component is selected from the group consisting of Al₂O₃, aluminosilicates, silica, and zeolites, alternatively from the group consisting of Zeolite Y, Zeolite Beta, Zeolite A, Zeolite X, Zeolite L, and mixtures thereof, alternatively from the group consisting of Zeolite Y and Zeolite Beta.

In some embodiments, the inorganic carrier of the hydrogenating component is the depolymerizing component.

In some embodiments, the hydrocracking catalyst is a physical mixture of a hydrogenation catalyst made from or containing the hydrogenating component and a depolymerization catalyst made from or containing the depolymerizing component.

In some embodiments, the inorganic carrier of the hydrogenating component has a pore volume of from 0.2 to 4 ml/g.

In some embodiments, the hydrocracking catalyst is made from or containing active hydrogenation species in an amount from 0.5 to 25 wt. %, based on the total weight of the hydrocracking catalyst.

In some embodiments, the hydrocracking catalyst and the feedstock of polymeric waste material are fed into the reactor at a catalyst-to-feed (C/F) ratio of from 1:500 to 1:10.

In some embodiments, the hydrodepolymerization is carried out at a temperature from 200 to 550° C., alternatively from 300 to 450° C.

In some embodiments, the polymeric waste material is made from or containing a plastic material selected from the group consisting of polyethylene (PE), polypropylene (PP), polystyrene (PS), polyethylene terephthalate (PET), polyvinylchloride (PVC), polyamide (PA), polyurethane (PU), polyacrylonitrile (PAN), polybutylene (PB), and mixtures thereof.

In some embodiments, the polymeric waste material has a total content of volatiles, measured as weight loss at 100° C. and a pressure of 200 mbar over a period of 2 hours, of less than 10 wt. %, alternatively less than 5 wt. %, alternatively less than 2 wt. %, alternatively less than 1 wt. %, based on the total weight of the polymeric waste material.

In some embodiments, the polymeric waste material is a shredded polymeric waste material having a bulk density, determined according to DIN 53466, from 50 to 500 g/1, alternatively from 75 to 400 g/1. In some embodiments, the polymeric waste material is in pellet form, having a bulk density from 300 to 700 g/1, determined according to DIN 53466.

In some embodiments, the polymeric waste has a polyolefin content, alternatively a content of polypropylene (PP) or of polyethylene (PE). In some embodiments, the polyolefin content is more than 50 wt. %, alternatively more than 60 wt. %, alternatively more than 70 wt. %, alternatively more than 80 wt. %, alternatively more than 90 wt. %, based on the total weight of the polymeric waste material feedstock.

In some embodiments, the polymeric waste material has a total chlorine content less than 1.0 wt. %, alternatively less than 0.5 wt. %, based on the total weight of the polymeric waste material.

In some embodiments, the hydrodepolymerization product has a content of olefinic compounds, expressed as bromine number of less than 20, alternatively less than 15, alternatively no more than 10, based on the total weight of the hydrodepolymerization product. In some embodiments, the ¹H-NMR spectrum of the hydrodepolymerization product shows less than 10 mol %, alternatively less than 5 mol %, alternatively no more than 3 mol %, of aromatic protons.

In some embodiments, the present disclosure provides a process for preparing the hydrogenating component of the hydrocracking catalyst includes the steps of:
a) providing a precursor compound in the form of a salt for a metal selected from the group consisting of Fe, Mo, W, Ti, Ni, Cr, V, Co, Zr, and mixtures thereof;
b) dissolving the precursor compound in a polar solvent;
c) providing an inorganic carrier;
d) depositing the dissolved precursor compound on the inorganic carrier by incipient wetness impregnation, thereby obtaining a hydrogenating component precursor;
e) drying the hydrogenating component precursor;
f) treating the dried hydrogenating component precursor at a temperature from 200 to 850° C., thereby yielding a product; and
g) cooling the product of step f), thereby obtaining the hydrogenating component of the hydrocracking catalyst.

In some embodiments, the present disclosure provides a feedstock for a steam cracker made from or containing a hydrodepolymerization product. In some embodiments, the present disclosure provides a process for steam cracking a feedstock include the step of providing the hydrodepolymerization product as a feedstock.

In some embodiments, the present disclosure provides a hydrocracking catalyst for hydrodepolymerization of polymeric waste material, made from or containing (a) a hydrogenating component made from or containing a metal selected from the group consisting of Fe, Mo, W, Ti, Ni, Cr, V, Co, Zr, and mixtures thereof, supported on an inorganic carrier and (b) a depolymerizing component being an acidic compound. In some embodiments, the present disclosure provides a process for hydrodepolymerization of polymeric waste material including the step of providing the hydrocracking catalyst.

In some embodiments, the present disclosure provides a process including the step of combining (a) the hydrogenating component of the hydrocracking catalyst with (b) a depolymerization catalyst made from or containing the depolymerizing component being an acidic compound. In some embodiments, the depolymerizing component is selected from the group consisting of Al₂O₃, aluminosilicates, silica, and zeolites, alternatively from the group consisting of Zeolite Y, Zeolite Beta, Zeolite A, Zeolite X, Zeolite L, and mixtures thereof, alternatively from the group consisting of Zeolite Y and Zeolite Beta.

In some embodiments, the present disclosure provides a process for producing olefins, including the steps of
i) providing a feedstock of polymeric waste material;
ii) mixing the feedstock of polymeric waste material with a hydrocracking catalyst made from or containing
   (a) a hydrogenating component made from or containing a metal selected from the group consisting of Fe, Mo, W, Ti, Ni, Cr, V, Co, Zr, and mixtures thereof, supported on an inorganic carrier and
   (b) a depolymerizing component being an acidic compound;
iii) introducing the mixture into a reactor and treating the mixture with hydrogen;
iv) separating the content of the reactor, thereby obtaining a liquid or liquefiable hydrodepolymerization product and gaseous fractions;
v) optionally collecting the gaseous fractions; and
vi) introducing the hydrodepolymerization product into a steam cracker for forming a product made from or containing olefins.

### DETAILED DESCRIPTION OF THE DISCLOSURE

In some embodiments, the present disclosure provides a process for the hydrodepolymerization of polymeric waste material is provided, including the steps of:
i) providing a feedstock of polymeric waste material;
ii) mixing the feedstock of polymeric waste material with a hydrocracking catalyst made from or containing
   (a) a hydrogenating component made from or containing a metal selected from the group consisting of Fe, Mo, W, Ti, Ni, Cr, V, Co, Zr, and mixtures thereof, supported on an inorganic carrier and
   (b) a depolymerizing component being an acidic compound;
iii) depolymerizing the mixture in the presence of hydrogen, thereby yielding a reactor content made from or containing the hydrocracking catalyst, gaseous reaction products, and a hydrodepolymerization product;
iv) optionally collecting the gaseous reaction products;
v) separating the content of the reactor, thereby obtaining the hydrodepolymerization product;
vi) optionally, re-introducing the hydrocracking catalyst or gaseous reaction products into the reactor.
   In some embodiments, the depolymerizing component is selected from the group consisting of Al₂O₃, aluminosilicates, silica, and zeolites, alternatively from the group consisting of Zeolite Y, Zeolite Beta, Zeolite A, Zeolite X, Zeolite L, and mixtures thereof, alternatively from the group consisting of Zeolite Y and Zeolite Beta.

In some embodiments and if present in the hydrodepolymerization product, constituents selected from the group consisting of aromatic compounds, char, dioxins, gaseous reaction products, and olefinic compounds are in amount such that the hydrodepolymerization product is directly fed into a steam cracker for further processing, without further purification or pre-treatment. In some embodiments, the hydrodepolymerization product is directly fed into a steam cracker for further processing, without further purification or pre-treatment.

### Polymeric Waste Material Feedstock

In some embodiments, the hydrodepolymerization process of the present disclosure permits recycling polymeric waste materials such as plastic waste materials and cracker oil residues. In some embodiments, the polymeric waste material feedstock is made from or containing polymeric materials, alternatively synthetic polymers. In some embodiments, the polymeric materials are selected from the group consisting of polyolefins, polystyrene, polyethylene terephthalate (PET), polyvinyl chloride (PVC), polyamide, polycarbonate, polyurethane, polyester, natural and synthetic rubber, tires, filled polymers, composites and plastic alloys, and plastics dissolved in a solvent. In some embodiments, the polyolefins are selected from the group consisting of polyethylene and polypropylene. In some embodiments, the polymeric waste material feedstock is made from or containing other hydrocarbon materials. In some embodiments, the hydrocarbons include biomass. In some embodiments, the feedstock for the hydrodepolymerization process is made from or containing other hydrocarbons. In some embodiments and to produce light gas olefins, the plastics feedstock is made from or containing polyolefins. In some embodiments, the feedstock is made from or containing a mixture of plastics and hydrocarbon materials.

In some embodiments, the polymeric waste material feedstock is made from or containing a type of polymeric waste material, alternatively a mixture of two or more different polymeric waste materials. In some embodiments, the polymeric waste material feedstock is made from or containing materials of different forms. In some embodiments, the polymeric waste material feedstock is in the form of a powder. In some embodiments, the polymeric waste material feedstock is in the form of pellets, shredded flakes, or pieces of film. In some embodiments, the pellets have a particle size from 1 to 20 mm, alternatively from 2 to 10 mm, alternatively from 2 to 8 mm. In some embodiments, the shredded flakes or pieces of film have a particle size from 1 to 20 mm. As used herein, a “particles size range” indicates that 90 wt. % of the particles have a diameter within the range. In some embodiments, particle size is determined by sieving or using a Beckman Coulters LS13320 laser diffraction particle size analyzer. In some embodiments, the polymeric waste material feedstock is made from or containing ethylene cracker residue (ECR). As used herein, the term “polymeric materials” refers to materials having a weight average molecular weight of at least 500 g/mol, alternatively from 500 g/mol to 20,000,000 g/mol, alternatively from 1,000 g/mol to 15,000,000 g/mol, alternatively from 2,000 g/mol to 10,000,000 g/mol.

In some embodiments, the polymeric waste material feedstock is made from or containing from 50 to 99 wt. %, alternatively from 60 to 97 wt. %, alternatively from 70 to 95 wt. %, alternatively from 75 to 97 wt. %, of polymeric waste material, based upon the total weight of the polymeric waste material feedstock.

In some embodiments, the polymeric waste material is made from or containing plastics material. In some embodiments, the polymeric waste material is named after the type of polymer which forms the predominant component of the polymeric waste material. In some embodiments, the polymeric waste material feedstock is made from or containing more than 25 wt. %, alternatively more than 40 wt. %, alternatively more than 50 wt. %, of the polymeric material, based upon the total weight of the polymeric waste material feedstock. In some embodiments, the polymeric waste material is further made from or containing additives. In some embodiments, the additives are selected from the group consisting of fillers, reinforcing materials, processing aids, plasticizers, pigments, light stabilizers, lubricants, impact modifiers, antistatic agents, inks, and antioxidants.

In some embodiments, the polymeric waste materials are made from or containing polyolefins and polystyrene. In some embodiments, the polyolefins are selected from the group consisting of high-density polyethylene (HDPE), low-density polyethylene (LDPE), ethylene-propylene-diene monomer (EPDM), and polypropylene (PP). In some embodiments, the polymeric waste materials are made from or containing a mixture of polyolefins and polystyrene.

In some embodiments, the polymeric waste materials are selected from the group consisting of polyvinyl chloride, polyvinylidene chloride, polyethylene terephthalate, polyurethane (PU), acrylonitrile-butadiene-styrene (ABS), nylon, and fluorinated polymers. In some embodiments, the polymeric waste material feedstock is made from or containing less than 50 wt. %, alternatively less than 30 wt. %, alternatively less than 20 wt. %, alternatively less than 10 wt. %, of polymeric waste materials selected from the group consisting of polyvinyl chloride, polyvinylidene chloride, polyethylene terephthalate, polyurethane (PU), acrylonitrile-butadiene-styrene (ABS), nylon, fluorinated polymers, and mixtures thereof, based upon of the total weight of the polymeric waste material feedstock.

In some embodiments, the polymeric waste material is made from or containing a thermoplastic polymer. In some embodiments, the polymeric waste material is essentially free of thermosetting polymers. As used herein, the term “essentially free” refers to having a content less than 15 wt. %, alternatively less than 10 wt. %, alternatively less than 5 wt. %, of thermosetting polymers, based upon the total weight of the polymeric waste material feedstock.

In some embodiments, the polymeric waste materials are selected from the group consisting of single plastic waste, single virgin plastic on spec or off spec, mixed plastics waste, rubber waste, cracker oil residue, biomass, and mixtures thereof. In some embodiments, the polymeric waste materials are selected from the group consisting of single plastic waste, single virgin plastic off spec, mixed plastics waste, rubber waste, and mixtures thereof. In some embodiments, the polymeric waste materials are selected from the group consisting of single virgin plastic off-spec, mixed plastics waste, and mixtures mixture thereof.

In some embodiments, the polymeric waste materials are further made from or containing limited quantities of non-pyrolyzable components. In some embodiments, the non-pyrolyzable components are selected from the group consisting of water, glass, stone, and metal. In some embodiments and as used herein, the term “limited quantities” refers to an amount of less than 50 wt. %, alternatively less than 20 wt. %, alternatively less than 10 wt. %, of the non-pyrolyzable components, based upon the total weight of the polymeric waste material feedstock.

In some embodiments, the polymeric waste material is extruded prior to being employed as feedstock. In some embodiments, the polymeric waste material is pelletized, and the pellets are employed as feedstock. In some embodiments, the polymeric waste material is fed into the reactor in a molten state. In some embodiments, the polymeric waste material is fed into the reactor in a molten state at temperatures from 200° C. to 300° C.

In some embodiments, the polymeric waste material employed has at least one of the following features:
i) less than 10 wt. %, alternatively less than 5 wt. %, alternatively less than 2 wt. %, alternatively less than 1 wt. %, of a total content of volatiles (TV) measured as weight loss at 100° C. and a pressure of 200 mbar over a period of 2 hours, based on the total weight of the polymeric waste material feedstock;
ii) (a) being shredded, being optionally compacted, and having a bulk density from 50 to 500 g/1, alternatively from 75 to 400 g/l or (b) being in pellet form and having a bulk density from 300 to 700 g/1, wherein the bulk density being determined according to DIN 53466;
iii) more than 50 wt. %, alternatively more than 60 wt. %, alternatively more than 70 wt. %, alternatively more than 80 wt. %, alternatively more than 90 wt. %, of polyolefin content, alternatively of polypropylene (PP) or polyethylene (PE) content, based on the total weight of the polymeric waste material feedstock;
iv) less than 10 wt. %, alternatively less than 5 wt. %, alternatively less than 3%, of polar polymer contaminants, based on the total weight of the polymeric waste material;
v) less than 10 wt. %, alternatively less than 5 wt. %, alternatively less than 3%, of cellulose, wood, or paper, based on the total weight of the polymeric waste material;
vi) less than 1.0 wt. %, alternatively less than 0.5 wt. %, alternatively less than 0.1 wt. %, of total chlorine content, based on the total weight of the polymeric waste material; and
vii) less than 10 wt. %, alternatively less than 5 wt. %, alternatively less than 2 wt. %, alternatively less than 1 wt. %, of total ash content determined as residue after heating the polymeric waste at 800° C. for 120 hours in air, based on the total weight of the polymeric waste material. In some embodiments, the ash content is from 0.01 to 2 wt. %, alternatively from 0.02 to 1.5 wt. %, alternatively from 0.05 to 1.0 wt. %.

In some embodiments, the polymeric waste materials are defined by upper limits of minor components, constituents, or impurities, expressed as percent by weight. In some embodiments, the lower limits for these components, constituents, or impurities are below the detection limit, alternatively 0.001 wt. %, alternatively 0.01 wt. %, alternatively 0.1 wt. %, respectively.

In some embodiments, moving beds, drums, and screens, and air separators are used to differentiate materials in a polymeric waste stream by size, weight, or density. In some embodiments, sorting of plastic waste stream, which is made from or containing polyolefins, is achieved by spectroscopy techniques (MIR, NIR [near-infrared]), X-Ray, or fluorescence spectroscopy.

In some embodiments, automatic separation techniques of waste plastic materials are selected from the group consisting of dry sorting, electrostatic sorting, mechanical sorting, wet sorting, and chemical sorting. In some embodiments, mechanical sorting involves centrifugal force, specific gravity, elasticity, particle shape, selective shredding, or mechanical properties. In some embodiments, wet sorting is sink-float sorting.

In some embodiments, the feedstock is prepared using sorting techniques summarized in B. Ruj et al: Sorting of plastic waste for effective recycling, Int. J. Appl. Sci. Eng. Res 4, 2015, 564-571.

### Hydrocracking Catalyst

In some embodiments, the process is carried out in the presence of a hydrocracking catalyst made from or containing (a) a hydrogenating component made from or containing a metal selected from the group consisting of Fe, Mo, W, Ti, Ni, Cr, V, Co, Zr, and mixtures thereof, as active hydrogenation species, supported on an inorganic carrier. In some embodiments, the catalyst is employed in the hydrodepolymerization reaction, thereby yielding a hydrodepolymerization product with low aromatic and olefinic content. In some embodiments, the hydrodepolymerization product is directly employed as feedstock for steam cracking. In some embodiments, the active hydrogenation species are mixtures selected from the group consisting of Fe/Mo, Fe/W, Ni/Mo, Ni/W, Cr/Mo, Ni/V, Ni/Co, and Cr/W.

In some embodiments, the carrier is selected from the group consisting of SiO₂, Al₂O₃, AlPO₄, and Al/Si mixed oxide. As used herein, the term “Al/Si mixed oxide” refers to a material made from or containing a mixture of Al₂O₃ and SiO₂, having a neutral structure.

In some embodiments, the hydrocracking catalyst is further made from or containing (b) a depolymerizing component being an acidic compound. In some embodiments, the depolymerizing component is selected from the group consisting of Al₂O₃, aluminosilicates, silica, and zeolites. As used herein, the term “zeolites” refers to crystalline microporous aluminosilicates which are built up from corner-sharing SiO₄⁻ and AlO₄- tetrahedrons having the general structure Mₙ+x/n [AlO₂]⁻x (SiO₂)y]⁺ zH₂O with n being the charge of the cation M and z defining the number of water molecules incorporated into the crystal structure. In some embodiments, the cation M is an alkaline ion, alkaline earth metal ion, or hydrogen ion. In some embodiments, the cation M is an ion selected from the group consisting of H⁺, Na⁺, Ca²⁺, K⁺, and Mg²⁺. Zeolites differ from mixed Al/Si oxides by pore structure and ionic character. In some embodiments, the zeolite is selected from the group consisting of Zeolite Y, Zeolite Beta, Zeolite A, Zeolite X, Zeolite L, and mixtures thereof, alternatively from the group consisting of Zeolite Y and Zeolite Beta. In some embodiments, the zeolites are wherein the metal ion M is substituted by a hydrogen. In some embodiments, the zeolite is selected from the group consisting of ZSM-5, ZSM-11, ZSM-22, ZSM-23, ZSM-35, ZSM-48, ZSM-50, TS-1, TS-2, SSZ-46, MCM-22, MCM-49, FU-9, PSH-3, ITQ-1, EU-1, NU-10, silicalite-1, silicalite-2, boralite-C, boralite-D, BCA, and mixtures thereof. In some embodiments, the depolymerizing component is made from or containing an amorphous-type compound. In some embodiments, the amorphous-type compound is made from or containing silica, alumina, kaolin, clay, and mixtures thereof. In some embodiment, the silica is in the form of sand.

In some embodiments, the inorganic carrier of the hydrogenating component of the hydrocracking catalyst is the depolymerizing component of the hydrocracking catalyst. In some embodiments, the metal selected from the group consisting of Fe, Mo, W, Ti, Ni, Cr, V, Co, Zr, and mixtures thereof is supported on the depolymerizing component, which acts as carrier.

In some embodiments, the inorganic carrier of the hydrogenating component is an Al/Si mixed oxide. In some embodiments, the composition of the Al/Si mixed oxide is adjustable. In some embodiments, the carrier contains Al₂O₃ in an amount from 20 to 99 wt. %, alternatively from 30 to 80 wt. %, alternatively from 40 to 70 wt. %, based on the total weight of the carrier. In some embodiments, the carrier contains SiO₂ in an amount from 1 to 80 wt. %, alternatively from 20 to 70 wt. %, alternatively from 30 to 60 wt. %, based on the total weight of the carrier.

In some embodiments, the inorganic carrier is made from or containing an excess of Al₂O₃. In some embodiments, the weight ratio of Al₂O₃ to SiO₂ in the carrier is from 99:1 to 30:70, alternatively from 9:1 to 3:2, alternatively from 4:1 to 3:2.

In some embodiments, the determination of the SiO₂ and Al₂O₃ content of the inorganic carrier is carried out by atomic emission spectroscopy using an inductively coupled plasma (ICP-AES).

In some embodiments, the average particle size D50 of the carrier is from 5 to 300 vim, alternatively from 5 to 100 vim, alternatively from 10 to 80 vim, alternatively from 10 to 50 vim, alternatively from 15 to 40 vim. In some embodiments, the carrier has a particle size D50 of from 20 to 50 vim. As used herein, the “volume-median diameter D50” refers to the portion of the particles with diameters smaller or larger than this value being 50%. In some embodiments, the volume-median diameter D50 is determined according to Coulter counter analysis in accordance with ASTM D4438. In some embodiments, at least 5% by volume of the particles of the inorganic carrier have a particle size in the range of from 0.1 to 3 μm, alternatively at least 40% by volume of the particles of the inorganic carrier have a particle size from 0.1 to 12 vim, alternatively at least 75% by volume of the particles of the inorganic carrier have a particle size in the range from 0.1 to 35 vim, the % by volume being based on the total volume of the particles.

In some embodiments, the inorganic carrier has an average pore size of from 1 to 100 nm, alternatively from 2 to 80 nm, alternatively from 5 to 60 nm, determined by BET method.

As used herein, the term “pore size” refers to the distance between two opposite walls of a pore, that is, the diameter of the pore in case of cylindrical pores and the width of the pore in case of slip-shaped pores, respectively.

In some embodiments, the method of BET is as described in S. Brunauer et al., Journal of the American Chemical Society, 60, p. 209-319, 1929.

In some embodiments, the inorganic carrier has a pore volume of from 0.2 to 4 ml/g, alternatively from 0.5 to 3 ml/g, alternatively from 0.6 to 2 ml/g, alternatively from 0.8 to 2 ml/g.

In some embodiments, the inorganic carrier has a water content from 0.2 to 10%, alternatively from 0.3 to 5%, based on the total content of the carrier and determined by Karl-Fischer titration.

In some embodiments, the inorganic carrier has a specific surface from 5 to 800 m²/g, alternatively from 100 to 600 m²/g, alternatively from 150 to 500 m²/g, alternatively from 100 to 400 m²/g, determined according to the BET method.

In some embodiments, the hydrocracking catalyst is made from or containing the active hydrogenation species in an amount from 0.5 to 25 wt. %, alternatively 1 to 20 wt. %, alternatively 3 to 15 wt. %, based on the total weight of the hydrocracking catalyst. In some embodiments, the hydrocracking catalyst is made from or containing a mixture of active hydrogenation species. In some embodiments, the active hydrogenation species, supported on the inorganic carrier, are mixtures selected from the group consisting of Fe/Mo, Fe/W, Ni/Mo, Ni/W, Cr/Mo, Ni/V, Ni/Co, and Cr/W.

In some embodiments, the hydrocracking catalyst is further made from or containing dopant materials, thereby modifying the catalytic properties of the hydrocracking catalyst. In some embodiments, the dopant materials are selected from the group consisting of ammonium salts, fluorides, and nitrogen. In some embodiments, the ammonium salts are selected from the group consisting of NH₄X (wherein X═F, Cl, or Br), NH₄HF₂, (NH₄)₂SiF₆, (NH₄)₂SbF₆, (NH₄)₂TiF₆, (NH₄)PF₆, (NH₄)₂SiF₆, (NH₄)₂ZrF₆, NH₄BF₄, NH₄F, (NH₄)₂TaF₇, NH₄NbF₄, (NH₄)₂GeF₆, (NH₄)₂SmF₆, (NH₄)₂TiF₆, and (NH₄)₂ZrF₆. In some embodiments, the fluorides are selected from the group consisting of MoF₆, ReF₆, GaF₃, SO₂ClF, F₂, SiF₄, SF₆, ClF₃, ClF₅, BrF₅, IFS, NF₃, HF, BF₃, and NHF₂.

In some embodiments, the hydrocracking catalyst is a physical mixture of a hydrogenation catalysts made from or containing the hydrogenating component and a depolymerization catalyst made from or containing the depolymerizing component, thereby improving (i) the yield of the hydrodepolymerization process and (ii) the liquid content of the product. In some embodiments, the inorganic carrier of the hydrogenating component is not the depolymerizing component. In some embodiments, the particles of hydrogenation catalysts and the particles of the depolymerization catalyst are physically mixed. In some embodiments, the depolymerization catalyst is an acidic compound, selected from the group consisting of Al₂O₃, aluminosilicates, silica, and zeolites. In some embodiments, the zeolite is selected from the group consisting of Zeolite Y, Zeolite Beta, Zeolite A, Zeolite X, Zeolite L, and mixtures thereof, alternatively selected from the group consisting of Zeolite Y and Zeolite Beta. In some embodiments, the zeolites are wherein the metal ion M is substituted by a hydrogen. In some embodiments, the zeolite is selected from the group consisting of ZSM-5, ZSM-11, ZSM-22, ZSM-23, ZSM-35, ZSM-48, ZSM-50, TS-1, TS-2, SSZ-46, MCM-22, MCM-49, FU-9, PSH-3, ITQ-1, EU-1, NU-10, silicalite-1, silicalite-2, boralite-C, boralite-D, BCA, and mixtures thereof. In some embodiments, the depolymerization catalyst is made from or containing an amorphous-type compound. In some embodiments, the amorphous-type compound is made from or containing silica, alumina, kaolin, or mixtures thereof. In some embodiments, the silica is in the form of sand.

In some embodiments, the weight ratio of hydrogenation catalyst to depolymerization catalyst in the physical mixture depends on the composition of the polymeric waste material and is adjustable. In some embodiments, the weight ratio of hydrogenation catalyst to depolymerization catalyst is from 100:1 to 1:10, alternatively from 10:1 to 1:5, alternatively from 5:1 to 1:3, alternatively from 1:1 to 3:1.

In some embodiments, the hydrogenation reduces the content of organic heteroatoms in the hydrocarbons, thereby producing hydrogenation products. In some embodiments, the hydrogenation products are selected from the group consisting of H₂O, H₂S, alcohols, amines, and NH₃. In some embodiments, the hydrogenation products are separated from gaseous hydrocarbon products. In some embodiments, the separation occurs by caustic scrubber units.

In some embodiments, the present disclosure provides a process for preparing the hydrogenating component of the hydrocracking catalyst, including the following steps of:
a) providing a precursor compound in the form of a salt for a metal selected from the group consisting of Fe, Mo, W, Ti, Ni, Cr, V, Co, Zr, and mixtures thereof;
b) dissolving the precursor compound in a polar solvent, alternatively a protic solvent, alternatively an alcohol, alternatively water;
c) providing an inorganic carrier selected from the group consisting of SiO₂, Al₂O₃, AlPO₄, and Al/Si mixed oxide;
d) depositing the dissolved precursor compound on the inorganic carrier by incipient wetness impregnation, thereby obtaining a hydrogenating component precursor;
e) drying the hydrogenating component precursor;
f) treating the dried hydrogenating component precursor at a temperature from 200 to 850° C., thereby yielding a product; and
g) cooling the product of step f), thereby obtaining the hydrogenating component of the hydrocracking catalyst.

In some embodiments, the precursor compound is selected from the group consisting of inorganic or organic metal salts. In some embodiments, the precursor compound is selected from the group consisting of oxides, hydroxides, carbonates, nitrates, nitrites, chlorides, bromides, iodides, sulfites, sulfates, acetylacetonates, citrates, formates, acetates tetrafluoroborates, hexafluorosilicates, hexafluoroaluminates, hexafluorophosphates, phosphates, phosphites, oxalates, gluconates, malonates, and mixtures thereof. In some embodiments, the precursor compound is selected from the group consisting of salts of heteropoly acids of W, Mo, and V. In some embodiments, the precursor compound is selected from the group consisting of metatungstates, metamolybdates, and metavanadates.

In some embodiments, the dried hydrogenating component precursor is calcinated. In some embodiments, the process further includes the step of calcinating the dried hydrogenating component precursor at elevated temperatures, alternatively in a gas flow. In some embodiments, the gas is selected from the group consisting of air, oxygen, nitrogen, and argon, alternatively a sequence of different gas atmospheres of those gases.

In some embodiments, the treatment of step f) is carried out at a temperature from 200 to 850° C., alternatively from 230 to 550° C., alternatively from 400 to 700° C., alternatively from 250 to 600° C. In some embodiments, nitrogen, oxygen, argon, or air is used as purging gas during calcination/activation. In some embodiments, nitrogen, oxygen, argon, or air is used in a sequence of (i) heating up under nitrogen or argon; (ii) calcination in air or oxygen; and (iii) cooling down under nitrogen or argon. In some embodiments, reducing gases such as hydrogen, carbon monoxide, H₂S, and ethylene are employed during step f). In some embodiments, step f) is carried out in an oven, furnace, rotary kiln, or fluidized-bed activator.

In some embodiments, the process for preparing the hydrocracking catalyst further includes a step of mixing the hydrogenating component as hydrogenation catalyst with a depolymerizing component as depolymerization catalyst. In some embodiments, the depolymerizing component is an acidic compound, alternatively selected from the group consisting of Al₂O₃, aluminosilicates, silica, and zeolites, alternatively from the group consisting of Zeolite Y, Zeolite Beta, Zeolite A, Zeolite X, Zeolite L, and mixtures thereof, alternatively from the group consisting of Zeolite Y and Zeolite Beta.

In some embodiments, the hydrocracking catalyst and the polymeric waste material feedstock are mixed in step ii). In some embodiments, the mixing is carried out prior to introduction into a reactor. In some embodiments, the hydrocracking catalyst and the polymeric waste material are fed separately into the reactor. As used herein, the term “catalyst-to-feed (C/F) ratio” refers to the weight ratio of the amount of polymeric waste material feedstock fed into the reactor to the amount of hydrocracking catalyst fed into the reactor. In some embodiments, longer contact times are used with a low C/F ratio. In some embodiments, shorter contact times are used with a high C/F ratio. In some embodiments, the hydrocracking catalyst and the feedstock of organic polymeric waste material are fed into the reactor at a C/F ratio of from 1:500 to 1:10, alternatively from 1:100 to 1:15. In some embodiments, the hydrocracking catalyst and the polymeric waste material feedstock are mixed homogenously in a liquid hydrocarbon prior to feeding the hydrocracking catalyst and the polymeric waste material feedstock into the hydrodepolymerization reactor.

In some embodiments, the polymeric waste material is preheated to 200° C. to 300° C. and then mixed with the hydrocracking catalyst in a hydrocarbon stream in a vessel prior to being feed into the reactor. In some embodiments, the polymeric waste material is preheated by an extruder.

In some embodiments, the depolymerization step is carried out continuously or discontinuously. In some embodiments, the depolymerization step is carried out continuously. In some embodiments, the hydrodepolymerization reactor system is capable of handling pressures up to 500 bar and temperatures up to 600° C. In some embodiments, the high pressure reactor systems are alternatively useful in hydrocracking or hydrotreating processes in petroleum refining. In some embodiments, the high pressure reactor systems are alternatively useful in coal liquification processes such as the Bergius process. In some embodiments, the high pressure reactor systems are made from or containing one or more connected vessels with or without an agitator.

In some embodiments, the depolymerization step is carried out at a temperature of from 200 to 600° C., alternatively from 200 to 550° C., alternatively from 270 to 550° C., alternatively from 300 to 450° C.

In some embodiments, the hydrodepolymerization of the mixture of polymeric waste material and hydrocracking catalyst is conducted at a hydrogen pressure from 20 to 500 bar (2 MPa to 50 MPa), alternatively from 30 to 400 bar (3 to 40 MPa), alternatively from 100 to 350 bar (10 to 35 MPa). In some embodiments, the hydrodepolymerization is conducted discontinuously and conducted at an initial hydrogen pressure from 20 to 500 bar (2 to 50 MPa), alternatively from 30 to 400 bar (3 to 40 MPa), alternatively from 100 to 350 bar (10 to 35 MPa). As used herein, the term “initial hydrogen pressure” refers to the hydrogen pressure in the reactor after having provided the hydrogen at room temperature but before heating the reactor to the final reaction temperature. In some embodiments, the hydrodepolymerization is carried out at a hydrogen pressure from 20 to 90 bar (2 MPa to 9 MPa).

In some embodiments, the hydrodepolymerization is carried out continuously and the reactor content is continuously discharged from the reactor. In some embodiments, the residence time is set so to ensure conversion of the polymeric waste material. In some embodiments, a stream of reactor content from the reactor is discharged continuously. In some embodiments, both a liquid-phase stream and a gas-phase stream are continuously discharged from the reactor. In some embodiments, a first sub-step of the separation step iv) occurs in the reactor. In some embodiments, the streams discharged from the reactor are subjected to further sub-steps of the separation step iv).

In some embodiments, the separation is at least partly carried in a separation unit including a separator vessel and a fractionation unit, wherein a liquid hydrodepolymerization product is collected. In some embodiments, the separation unit further includes a cyclone for separating a gaseous hydrodepolymerization crude product from other components.

In some embodiments, the content of the reactor is separated into a liquid or liquefiable hydrodepolymerization product and various other fractions. In some embodiments, the separation is achieved by condensation, distillation, or filtration. In some embodiments, the liquid or liquefiable hydrodepolymerization product is obtained after separating off high boiling hydrocarbons, char, catalyst residues, and other solids contaminants. In some embodiments, the separation is achieved by distillation, decantation, or filtration.

In some embodiments, the hydrocracking catalyst or hydrogen-enriched gas fractions obtained in separation step iv) are re-introduced into the reactor.

In some embodiments, a liquid hydrocarbon stream separated off from the discharged reactor content is mixed with the polymeric waste material and the hydrocracking catalyst prior to be fed into the hydrodepolymerization reactor. In some embodiments, the liquid hydrocarbon stream is made from or containing solid residues and catalyst. In some embodiments, the liquid hydrocarbon stream is made from or containing solid residues and catalyst in a concentration of less than or equal to 20 wt. %, based upon the total weight of the liquid hydrocarbon stream.

In some embodiments, the energy efficient recycling of polymeric waste material refers to the use of the entirety of recovered materials. In some embodiments, the process includes a step of collecting the hydrogen-enriched gaseous fractions. In some embodiments, the hydrogen-enriched gaseous fractions are condensed and separated from side products. In some embodiments, the side products are selected from the group consisting of CO, CO₂, NH₃, H₂S, and water. In some embodiments, the hydrogen-enriched gaseous fractions are used in other processes. In some embodiments, the processes include the production of diene products made from or containing hydrogen and C1-C4 hydrocarbon fractions.

### Hydrodepolymerization Product

In some embodiments, the liquid or liquefiable hydrodepolymerization product has a low content of aromatic compounds, alternatively a low content of polycyclic aromatic compounds and asphaltanes, alternatively a low content of aromatic and olefinic components.

In some embodiments, the liquid or liquefiable hydrodepolymerization product has a boiling range from 30 to 650° C., alternatively from 50 to 250° C. In some embodiments, the hydrodepolymerization product is separated by distillation. In some embodiments, the hydrodepolymerization product is separated in hydrocarbon fractionations of different boiling ranges. In some embodiments, the hydrocarbon fractionations are made from or containing a light naphtha fraction having a boiling range from 30° C. and 130° C., a heavy naphtha fraction having a boiling range from 130° C. to 220° C., a kerosene fraction having a boiling range from 220° C. to 270° C., or other high boiling point fractions. In some embodiments, the light naphtha fraction is made from or containing C5 and C6 hydrocarbons having a boiling range from 30° C. and 130° C. In some embodiments, the heavy naphtha fraction is made from or containing C6 to C12 hydrocarbons. In some embodiments, the kerosene fraction is made from or containing C9 to C17 hydrocarbons. In some embodiments, the other high boiling point fractions are made from or containing diesel fuel, fuel oil, or hydrowax. In some embodiments, heavy fractions are sent back to an additional hydrodepolymerization step, thereby producing light hydrocarbon fractions, alternatively light distillate feedstock for steam crackers. In some embodiments, reactor conditions and catalysts affect the composition of the hydrodepolymerization product. In some embodiments, a light distillate cracker feedstock is prepared by using a higher amount of hydrogen and a longer residence time in the reactor. In some embodiments, hydrowax fractions having a boiling range from 300° C. to 550° C. are used as cracker feedstock. In some embodiments, the hydrodepolymerization product or fractions of the hydrodepolymerization product are blended with other feedstock prior to be used as cracker feed or as fuel.

In some embodiments, the hydrodepolymerization product has a content of residues upon evaporation, determined according to ASTM D381, of no more than 5 ppm (w).

In some embodiments, the hydrodepolymerization product has a content of residues upon evaporation, determined according to ASTM D381, of no more than 5 ppm (w).

In some embodiments, the content of aromatic compounds in the obtained hydrodepolymerization product is less than 10 mol %, alternatively less than 5 mol %, alternatively no more than 3 mol %, wherein the content of aromatic components is measured as contents of aromatic protons in mol % as determined by ¹H-NMR-spectroscopy

In some embodiments, the hydrodepolymerization product has a low content of olefinic compounds, alternatively less than 5 mol %, alternatively less than 3 mol %, alternatively less than 1.5 mol %, alternatively no more than 1 mol %, wherein the content of olefinic compounds is measured as the contents of olefinic protons as determined by ¹H-NMR-spectroscopy.

A measure for the content of double bonds is the Bromine number (BrNo.), which indicates the degree of unsaturation. In some embodiments, the hydrodepolymerization product has a Bromine number of less than 25 grams bromine per 100 grams of sample, alternatively from 0.1 to 20, alternatively from 0.2 to 15, alternatively from 0.3 to 10, alternatively from 0.5 to 5, determined according to ASTM D1159-01.

In some embodiments, the hydrodepolymerization product has a char content of less than 5 wt. %, alternatively less than 2 wt. %, based on the total weight of the hydrodepolymerization product.

In some embodiments, the hydrodepolymerization product is defined by upper limits of minor components, constituents, or impurity expressed as percent by weight. In some embodiments, the lower limits for these components, constituents, or impurity are below the detection limit, alternatively 0.001 wt. %, alternatively 0.01 wt. %, alternatively 0.1 wt. %, respectively.

In some embodiments, the hydrodepolymerization product has a low content of aromatic and olefinic compounds. In some embodiments, the hydrodepolymerization product is directly fed into a steam cracker for further processing, without further purification or pre-treatment. In some embodiments, the hydrodepolymerization product is used as feedstock in a steam cracker. In some embodiments, the hydrodepolymerization product is used as feedstock for the production of olefins.

In some embodiments, the inorganic carrier is selected from the group consisting of SiO₂, Al₂O₃, AlPO₄, and Al/Si mixed oxide. In some embodiments, the carrier is an Al/Si mixed oxide. In some embodiments, the Al/Si mixed oxide is made from or containing from 20 to 99 wt. %, alternatively from 30 to 80 wt. %, alternatively from 40 to 70 wt. %, of Al₂O₃, based on the total weight of the carrier. In some embodiments, the Al/Si mixed oxide is made from or containing from 1 to 80 wt. %, alternatively from 20 to 70 wt. %, alternatively from 30 to 60 wt. %, of SiO₂, based on the total weight of the carrier.

In some embodiments, the weight ratio of Al₂O₃ to SiO₂ in the mixed oxide is from 99:1 to 30:70, alternatively from 9:1 to 3:2, alternatively from 4:1 to 3:2.

In some embodiments, the determination of the SiO₂ and Al₂O₃content of the mixed oxide is carried out by atomic emission spectroscopy, using an inductively coupled plasma (ICP-AES).

In some embodiments, the hydrogenating component is made from or containing an active hydrogenation species selected from the group consisting of Cr, Ni, and Mo. In some embodiments, the inorganic carrier is a mixed Al/Si oxide, the weight ratio of Al₂O₃ to SiO₂ being from 4:1 to 3:2, and the active hydrogenation species supported on the mixed Al/Si oxide being selected from the group consisting of Cr, Ni, and Mo.

In some embodiments, the hydrodepolymerization product is used directly as feedstock in the production of olefinic materials. In some embodiments, the olefinic materials are selected from the group consisting of ethylene, propylene, and butylene. In some embodiments, the present disclosure provides a process for the production of olefins, including the steps of
i) providing a feedstock of polymeric waste material;
ii) mixing the feedstock of polymeric waste material with a hydrocracking catalyst made from or containing a metal selected from the group consisting of Fe, Mo, W, Ti, Ni, Cr, V, Co, Zr, and mixtures thereof, supported an inorganic carrier selected from the group consisting of SiO₂, Al₂O₃, AlPO₄, and Al/Si mixed oxide;
iii) introducing the mixture into a reactor and treating the mixture with hydrogen;
iv) separating the content of the reactor, thereby obtaining a liquid or liquefiable hydrodepolymerization product and gaseous fractions;
v) optionally, collecting the gaseous fractions; and
vi) introducing the hydrodepolymerization product into a steam cracker for forming a product made from or containing olefins.

In some embodiments, the hydrocracking catalyst, the polymeric waste material feedstock, and the conditions for carrying out the hydrodepolymerization are the same as described above.

The following examples are given to illustrate but not limit the present disclosure.

### Analytical Methods

The following analytical methods were employed:
1) GC MS was used for liquid and gas analysis.
2) Char residue was determined according to mass balance after decoking the residues of the reactor at 800° C.
3) Liquid contents were characterized using simulated distillation (SimDist) analysis according to ASTM D 7213: 2012.
4) The total content of unsaturated components in the liquid condensates were characterized via Bromine number determination using an 848 Titrino Plus (Metrohm AG, Herisau, Switzerland), equipped with a double PT-wire electrode which has integrated a PT1000 temperature sensor, and a 10 ml burette in accordance with ASTM D1159-01 as described in Metrohm Application Bulletin 177/5e, December 2018. The Bromine number (BrNo.) represents the amount of bromine in grams absorbed by 100 grams of a sample.
5) ¹H-NMR analysis was conducted by dissolving a sample of the liquid condensate in CDCl₃ and characterizing the sample using proton NMR spectroscopy. Aromatic, olefinic, and aliphatic protons were assigned, according to the chemical shifts summarized in Table 1:

TABLE 1
Integral Regions in ¹H-NMR spectroscopy

| Peak Assignment | 1H Chemical Shift (ppm) |
|---|---|
| I1 (Aromatic Protons) | 8.25-7.27 |
| CDCl3 -Solvent | 7.26 |
| I2 (Aromatic Protons) | 7.25-6.60 |
| I3 (Olefinic Protons - Type 2) | 6.60-5.95 |
| I4 (Olefinic Protons - Type 1) | 5.95-5.67 |
| I5 (Olefinic Protons - Type 2) | 5.67-5.35 |
| I6 (Olefinic Protons - Type 3) | 5.35-5.15 |
| I7 (Olefinic Protons - Type 1) | 5.15-4.85 |
| I8 (Olefinic Protons - Type 4) | 4.85-4.40 |
| I9 . . . (Paraffinic Protons) | 4.40-0.25 |

The listed types of olefinic protons were assumed to correspond to the following structures:

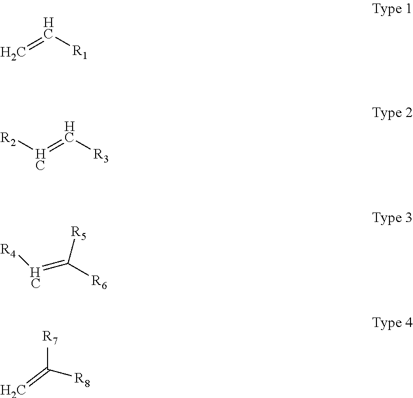

The amounts of aromatic, olefinic, and aliphatic protons were determined based on the assigned peak integrals according to the following equations:
Mol % Aromatic Protons=[(I₁+I₂)/(I₁+I₂+I₃+I₄+I₅+I₆+I₇+I₈+I₉)]%
Mol % Olefinic Protons Type 1=[(I₄+I₇)/(I₁+I₂+I₃+I₄+I₅+I₆+I₇+I₈+I₉)]%
Mol % Olefinic Protons Type 2=[(I₃+I₅)/(I₁+I₂+I₃+I₄+I₅+I₆+I₇+I₈+I₉)]%
Mol % Olefinic Protons Type 3=[(I₆)/(I₁+I₂+I₃+I₄+I₅+I₆+I₇+I₈+I₉)]%
Mol % Olefinic Protons Type 4=[(I₈)/(I₁+I₂+I₃+I₄+I₅+I₆+I₇+I₈+I₉)]%
Mol % Paraffinic Protons=[(I₉)/(I₁+I₂+I₃+I₄+I₅+I₆+I₇+I₈+I₉)]%
6) The water contents of the inorganic carriers, the hydrocracking catalysts, and the depolymerizing components were determined using a Sartorius MA45 (Sartorius AG, Goettingen, Germany) on a sample of 0.5 to 1 g at 180° C.
7) The pore volume was determined by adding water to the pulverulent substance until the pores were saturated with liquid, which was evidenced by the powder's loss flowability and starting to form lumps. The volume of water per gram of sample corresponded to the pore volume of the sample. Prior to pore volume measurement, the sample was dried for 2 hours at 180° C. and 100 mbar vacuum, thereby removing volatiles. For the determination, 5 g of the material were weighed out into a dry powder bottle (150 ml) with screw cap. Distilled water was added in portions from a burette, the bottle was sealed with the screw cap, and the contents were mixed by vigorous shaking. The bottle was then placed vigorously on a cork mat and subsequently rotated. When about ⅓ of the sample remained stuck to the base of the bottle, the pores were determined to be saturated. The water consumption was read and converted to a value based on 1 g of sample.
8) For the determination of a pH value of the hydrodepolymerization products, by extraction of a liquid sample of the hydrodepolymerization product was extracted with water in a volume ratio water:sample of 1:5 and the pH value of the aqueous solution was measured.
9) Properties of the polymeric waste material feedstock were determined as follows:
   Samples of from 20 to 100 g of the polymeric waste were milled and analyzed. Alternatively, a pelletized sample of the polymeric waste was analyzed. The following methods were used:
      i) Total Volatiles (TV) were measured as the weight loss of a 10 g sample at 100° C. and after 2 hours at 200 mbar.
      ii) Water content was determined by Karl-Fischer titration using an apparatus from Metrohm 915 KF Ti-Touch equipped with a PT100 indicator electrode for volumetric KF titration according to Metrohm Application Bulletin 77/3e in compliance with ASTM E203.
      iii) IR-Spectroscopy was used for a qualitative identification of various polymers (PP, PE, PS, PA, PET, PU, and Polyester) and additives such as CaCO3.
      iv) Standard elemental analysis was used for determination of wt. % of H, C, N (DIN 51732: 2014-07) and S (tube furnace, ELTRA GmbH, Haan, Germany, DIN 51724-3: 2012-07).
      v) ¹H-NMR was used for determining the composition of polymers soluble in solvents adequate for recording a ¹H-NMR spectrum: PE/PP balance (copolymers were also included), PET, and PS.
      vi) Ash Content analysis of plastics was determined at 800° C. according to DIN EN ISO 3451-1 (2019-05).
      vii) Bulk density of the polymer waste was determined according to DIN 53466.
      viii) Corrosivity was determined as the pH value of an aqueous solution, after a contact time of 3 h (5 g sample in 50 ml distilled water).
      ix) Inductively coupled plasma atomic emission spectroscopy (ICP-AES) was used for quantitative element determination (total chlorine content, content of Si, or content of metals).
      x) The ash content of a liquid feedstock such as pyrolysis oil, ethylene cracker residue (ECR), vacuum gas oil (VGO), and heavy vacuum gas oil (HVGO) was measured according to ASTM D482-19.

### Feedstocks:

The following polymeric waste materials were employed as feedstocks:
A: Pelletized agricultural and industrial packaging film
B: Mixed plastic waste of shredded flakes and small pieces of film
C: Flakes, fluff, and small pieces of film
D: Shredded film
E: Shredded and pelletized multilayer film
F: Ethylene Cracker Residue (ECR), also referred to as pitch or cracker oil, was a highly viscous brown-black liquid with a distinctive odor, which was produced during the manufacture of ethylene in a steam cracking process. In some instances, ECR was used as fuel. In some instances, ECR was used as fuel for power plants. The sample used contained 33% of asphaltenes measured as heptane insoluble according to IP143 and 44 mol % of aromatic protons by ¹H-NMR. The central boiling point (65%) was 486° C. by ASTM D1160. The ash content was <0.01 wt. %. The density was 1139 kg/m 3 at 15° C. (DIN12791).

The properties of the feedstocks are summarized in Table 2.

TABLE 2

| | | | | | | | | | | | Other |
|---|---|---|---|---|---|---|---|---|---|---|---|
| Feed- | Ash | TV | BD | Cl | PE + PP* | PE* | PP* | PET* | PS* | PA* | cont. |
| stock | wt % | wt % | g/cm3 | wt % | wt % | wt % | wt % | wt % | wt % | wt % | wt % |
| A | 1.5 | 0.1 | 494 | 0.01 | 95 | 83 | 12 | <0.1 | 0.7 | 0.5 | 3.8 |
| B | 1.6 | 1.8 | 180 | 0.06 | 87 | 41 | 46 | <1 | 8 | 0.5 | 3.5 |
| C | 3.8 | 1.8 | 250 | 0.06 | 93 | 52 | 41 | 0.2 | 1.8 | 2.2 | 2.8 |
| D | 0.5 | 3.5 | 65 | 0.09 | 95 | 52 | 43 | <0.1 | 1 | — | 4 |
| E | 0.4 | 0.2 | 530 | <0.01 | 72 | 20 | 52 | 12 | 0 | 10 | 6 |

*polymer composition by ¹H-NMR
Ash: ash content of the feedstock
TV: total volatiles of the feedstock
BD: bulk density
Cl: total chlorine content
PE: polyethylene content
PP: polypropylene content
PET: content of polyethylene terephthalate
PS: polystyrene content
PA: polyamide content
Other cont.: content of other contaminants

### Depolymerizing Components

Depolymerizing Component #1a: Al/Si mixed oxide with an average particle size of 30 μm, having a ratio of Al₂O₃ to SiO₂ of 60:40, was commercially available under the tradename of Siral 40 HPV from Sasol Germany GmbH, Hamburg, Germany. The pore volume was 1.5 ml/g.

Depolymerizing Component #1b: Zeolite Beta, was commercially available under the tradename Zeolyst Beta (CP811E-75) from PQ Corporation, Malvern, PA, USA. The pore volume was 0.3 ml/g.

### Hydrocracking Catalysts

Catalyst #2: 5%, based on the amount of Depolymerizing Component #1a, of Ni as Ni(NO₃)₂ solution in water was deposited on Depolymerizing Component #1a as inorganic carrier by incipient wetness method and dried to a free flowing powder. The catalyst precursor was introduced into a fluidized bed activator, and the temperature was increased to 300° C. while purging with nitrogen. At 300° C., the purge gas was changed to air, the temperature increased to 500° C. and maintained for 2 h before cooling to 300° C. The gas was switched from air to nitrogen before cooling to room temperature.

Catalyst #3: 5%, based on the amount of Depolymerizing Component #1a, of Cr as Cr(NO₃)₂ solution in methanol was deposited on Depolymerizing Component #1a as inorganic carrier by incipient wetness method and dried to a free flowing powder. The catalyst precursor was introduced into a fluidized bed activator, and the temperature was increased to 300° C. while purging with nitrogen. At 300° C. the purge gas was changed to air, the temperature increased to 500° C. and maintained for 2 h before cooling to 300° C. The gas was switched from air to nitrogen before cooling to room temperature.

Catalyst #4: physical mixture of 3 g of Catalyst #2, which was used as hydrogenation catalyst, and 3 g of a Zeolite Beta (Depolymerizing Component #1b), which was used as depolymerization catalyst.

Catalyst #5: physical mixture of 3 g of Catalyst #2 which was used as hydrogenation catalyst, and 1 g of a Zeolite Beta (Depolymerizing Component #1b), which was used as depolymerization catalyst.

Catalyst #6: 5%, based on the amount of Depolymerizing Component #1a, of Ni as Ni(NO₃)₂ and 10% of Mo, based on the amount of Depolymerizing Component #1a, as ammonium heptamolybdate (NH₄)₆Mo₇O₂₄ solution in water was deposited on Depolymerizing Component #1a as inorganic carrier by incipient wetness method and dried to a free flowing powder. The catalyst precursor was introduced into a fluidized bed activator, and the temperature was increased to 300° C. while purging with nitrogen. At 300° C., the purge gas was changed to air, the temperature increased to 500° C. and maintained for 2 h before cooling to 300° C. The gas was switched from air to nitrogen before cooling to room temperature.

Catalyst #7: physical mixture of 3 g of Catalyst #6, which was used as hydrogenation catalyst, and 1 g of a Zeolite Beta (Depolymerizing Component #1b), which was used as depolymerization catalyst.

### Hydrodepolymerization

In Runs #1 to #10 and #14 to #14, 57 g of Feedstock A and 3 g of catalyst were suspended in 60 g of hydrated, white oil (Ondina 4, Royal Dutch Shell Company) in a 500 ml autoclave under nitrogen atmosphere. The reactor was purged with hydrogen and pressurized with hydrogen at room temperature until the initial hydrogen pressure was reached. The mixture was then heated up to 150° C. and stirred for 30 min (mixing step). The reactor temperature was increased to the final reaction temperature over the course of 1 h, with constant stirring at 200 rpm. After maintaining the reaction temperature in the reactor for 1 h, the reactor was cooled down to 60° C. and depressurized. The product was collected by filtering of the reactor content.

Run #11 was a repetition of Run #7; however, Feedstock A and Catalyst #4 were suspended in 60 g of the pyrolysis oil obtained by thermal depolymerization in Comparative Run #C, instead of in hydrated white oil.

In Runs #15 and #16, the initial hydrogen pressure of 5 bar resulted in a hydrogen pressure during hydrodepolymerization in the range from 20 bar to 40 bar.

Run #17 was performed using Feedstock B, instead of Feedstock A.

Comparative Runs A, B, and E were repetitions of Runs #1 to #10 and #14 to #14; however, instead of using the hydrocracking catalyst, a depolymerizing component not including a hydrogenating component was used as catalyst. Comparative Run D was conducted at an initial hydrogen pressure of 2 bar corresponding to a hydrogen pressure during hydrodepolymerization in the range from 4 bar to 6 bar.

Details of the hydrodepolymerization such as catalyst, initial hydrogen pressure, and final reaction temperature as well as the results of the hydrodepolymerization are summarized in Table 3. Analytical data of the hydrodepolymerization products are summarized in Tables 4 and 5.

TABLE 3
Examples.

| | | P(H₂) | | Yield | | |
|---|---|---|---|---|---|---|
| | Cat. | [bar] | Temp. | Oil/Wax | | Gas |
| Run# | # | (initial) | [° C.] | [%] | Appearance | [wt. %] |
| A* | 1a | 51 | 500 | 75 | Turbid highly viscous black liquid | 25 |
| | | | | | with wax particles | |
| B* | 1b | 50 | 500 | 73 | Turbid viscous black liquid | 27 |
| 1 | 2 | 50 | 400 | 96 | White wax | 4 |
| 2 | 2 | 50 | 500 | 79 | Low viscous orange liquid | 21 |
| 3 | 2 | 50 | 550 | 71 | Low viscous red liquid | 29 |
| 4 | 2 | 125 | 500 | 77 | Low viscous pale yellow liquid | 23 |
| 5 | 3 | 51 | 450 | 94 | yellow wax | 6 |
| 6 | 4 | 125 | 400 | 60 | Low viscous orange liquid | 40 |
| 7 | 4 | 125 | 350 | 73 | Low viscous yellow liquid | 27 |
| 8 | 4 | 125 | 300 | 96 | black wax | 4 |
| | | | | | (containing cat., no filtration) | |
| 9 | 5 | 125 | 350 | 94 | Low viscous colorless liquid | 6 |
| 10 | 5 | 125 | 450 | 73 | Low viscous colorless liquid | 27 |
| C* | — | — | 500 | 79 | Turbid viscous black wax | 16 |
| 11 | 4 | 125 | 350 | 96 | Low viscous orange liquid | 4 |
| 14 | 6 | 125 | 400 | 70 | Low viscous colorless liquid | 30 |
| 15 | 6 | 5 | 400 | 97 | White wax | 3 |
| D* | 6 | 2 | 400 | — | Polymeric residue | 1 |
| 16 | 7 | 5 | 400 | 88 | Low viscous yellow liquid | 12 |
| E* | 1b | 5 | 400 | 87 | Viscous red-brown liquid | 11 |
| 17 | 7 | 125 | 450 | 79 | Low viscous brown liquid | 21 |

*comparative

TABLE 4

| | | | | Mol. | IBP | Boiling | FBP |
|---|---|---|---|---|---|---|---|
| | | | Mol % | mass | from | temp. 50% | from |
| | | | Olefin | Engler | SIM- | from SIM- | SIM- |
| | pH- | | from | Diagram | DEST | DEST | DEST |
| Run# | value | BrNo. | BrNo. | [g/mol] | [° C.] | [° C.] | [° C.] |
| A* | | 24 | — | — | 35.0 | 198.6 | 549.2 |
| B* | | 25 | — | — | — | — | — |
| 1 | | 3 | 3.0 | 240 | 34.8 | 360.1 | 728.4 |
| 2 | | 12 | 10.2 | 165 | 36.7 | 234.1 | 561.0 |
| 3 | | 17 | 14.4 | 145 | 34.2 | 196.3 | 532.0 |
| 4 | | 4 | 3.0 | 120 | 23.1 | 162.3 | 522.0 |
| 5 | | 5 | 11.8 | 370 | 144.3 | 474.9 | 680.7 |
| 6 | | 5 | 3.8 | 125 | 22.2 | 162.0 | 583.1 |
| 7 | | 8 | — | — | — | — | — |
| 8 | | 4 | — | — | — | — | — |
| 9 | | 10 | — | — | — | — | — |
| 10 | | 2 | 1.5 | 120 | 30.4 | 156.8 | 476.6 |
| C* | 4.0 | 74 | — | — | 76.0 | 297.7 | 614.7 |
| 11 | 6.5 | 14 | — | — | 36.3 | 135.6 | 476.3 |
| 14 | | 3 | — | — | — | — | — |
| 15 | | 6 | — | — | — | — | — |
| D* | | — | — | — | — | — | — |
| 16 | | 22 | — | — | — | — | — |
| E* | | 31 | — | — | — | — | — |
| 17 | | 6.7 | — | — | 26.9 | 179.6 | 539.2 |

*comparative

TABLE 5
¹H-NMR: mol % protons of specific type

| | | Olefin | Olefin | Olefin | Olefin | Olefin | |
|---|---|---|---|---|---|---|---|
| Run# | Aromatic | ALL | Type 1 | Type 2 | Type 3 | Type 4 | Aliphatic |
| A* | 5.74 | 1.29 | 0.17 | 0.89 | 0.23 | 0.00 | 93.370 |
| B* | 7.602 | 0.889 | 0.210 | 0.296 | 0.257 | 0.125 | 91.511 |
| 1 | 0.663 | 0.224 | 0.079 | 0.068 | 0.066 | 0.012 | 99.113 |
| 2 | 2.043 | 0.625 | 0.191 | 0.186 | 0.182 | 0.067 | 97.332 |
| 3 | 3.382 | 0.845 | 0.224 | 0.301 | 0.242 | 0.078 | 95.324 |
| 4 | 1.637 | 0.220 | 0.074 | 0.053 | 0.063 | 0.030 | 98.145 |
| 5 | 0.49 | 0.23 | 0.00 | 0.00 | 0.23 | 0.00 | 99.280 |
| 6 | 4.232 | 0.022 | 0.057 | 0.067 | 0.067 | 0.030 | 95.561 |
| 7 | 1.786 | 0.323 | 0.096 | 0.094 | 0.107 | 0.026 | 97.901 |
| 8 | — | — | — | — | — | — | — |
| 9 | 0.575 | 0.405 | 0.114 | 0.119 | 0.127 | 0.046 | 99.031 |
| 10 | 2.225 | 0.091 | 0.024 | 0.038 | 0.027 | 0.003 | 97.689 |
| C* | 3.440 | 8.702 | 1.664 | 4.428 | 1.650 | 0.960 | 90.132 |
| 11 | 1.084 | 0.660 | 0.214 | 0.145 | 0.166 | 0.135 | 98.259 |
| 14 | 1.572 | 0.088 | 0.020 | 0.042 | 0.024 | 0.002 | 98.340 |
| 15 | — | — | — | — | — | — | — |
| D* | — | — | — | — | — | — | — |
| 16 | 1.73 | 1.15 | — | — | — | — | 96.61 |
| E* | 8.73 | 2.05 | — | — | — | — | 89.22 |
| 17 | 3.377 | 0.917 | 0.260 | 0.391 | 0.206 | 0.060 | 95.707 |

*comparative

The data generated in Comparative Run A using Depolymerizing Component #1a show that, even in the presence of hydrogen, pyrolysis of plastic waste leads to a high olefinic waxy product with a high char content, as derivable from black color, and 5.7 mol-% of aromatic hydrogens/protons as determined by ¹H-NMR.

With Depolymerizing Component #1b as the depolymerization catalyst, pyrolysis of plastic waste in the presence of hydrogen leads to a high olefinic waxy product with a high char content, as derivable from black color, and 7.6 mol-% of aromatic hydrogens/protons, determined by ¹H-NMR.

In contrast thereto, Runs carried out in the presence of the hydrocracking catalyst of did not show char deposition in the product or on the reactor wall was observed. The pH of the obtained liquids increased from 4 for the Comparative Runs to 6 for the Runs in accordance with the present disclosure, thereby indicating that the process includes hydrotreating and hydrocracking reactions besides depolymerization.

Runs #6 to #10 demonstrates that the catalytic activity of the catalyst is improved by a combination of a hydrogenation catalyst with a depolymerization catalyst which is an acidic compound. By adjusting the ratio of hydrogenation catalyst to depolymerization catalyst, the depolymerization reaction is shifted.

Run #11 demonstrates that a pyrolysis oil obtained by thermal depolymerization of plastic waste yields a hydrodepolymerization product having an acceptable level of aromatic content for use as a feedstock.

Run #15 delivered hydrowax, which was liquid at 50° C. and had a Bromine number of 6 g/100 g, indicating highly saturated hydrocarbons.

The products obtained in Comparative Runs A, B, C and G are inhomogeneous, have a high wax content, and have high olefinic and aromatic contents. Therefore, the products would undergo refining before becoming useful as fuel or cracker feed. In the four runs, a reactor fouling was observed. The content of olefins and aromatics in the products demonstrated a low hydrogenation efficiency of the depolymerizing components when not combined with a hydrogenating component.

Further, a test was conducted using feedstock F (Run 12) and a 1:1 mixture of ECR/PW (feedstocks F and A) (Run 13). The results are summarized in Tables 6 and 7.

TABLE 6

| | | P(H₂) | | Yield | | | |
|---|---|---|---|---|---|---|---|
| | Cat. | [bar] | Temp. | Oil/Wax | | Gas | |
| Run# | # | (initial) | [° C.] | [%] | Appearance | [wt. %] | BrNo. |
| 12 | 2 | 125 | 350 | 99 | Low viscous red | 1 | 8.4 |
| | | | | | color liquid | | |
| 13 | 2 | 125 | 350 | 94 | Low viscous red | 6 | 4.8 |
| | | | | | color liquid | | |

TABLE 7
¹H-NMR: mol % protons of specific type

| | | Olefin | Olefin | Olefin | Olefin | Olefin | |
|---|---|---|---|---|---|---|---|
| Run# | Aromatic | ALL | Type 1 | Type 2 | Type 3 | Type 4 | Aliphatic |
| 12 | 9.927 | 0.061 | 0.022 | 0.012 | 0.015 | 0.013 | 90.019 |
| 13 | 8.852 | 0.051 | 0.019 | 0.010 | 0.011 | 0.011 | 91.103 |

1. A process for the hydrodepolymerization of polymeric waste material, comprising the steps of:
i) providing a feedstock of polymeric waste material;
ii) mixing the feedstock of polymeric waste material with a hydrocracking catalyst comprising
(a) a hydrogenating component comprising a metal selected from the group consisting of Fe, Mo, W, Ti, Ni, Cr, V, Co, Zr, and mixtures thereof, supported on an inorganic carrier and
(b) a depolymerizing component being an acidic compound;
iii) depolymerizing the mixture in the presence of hydrogen in a reactor at a hydrogen pressure from 20 to 500 bar, thereby yielding a reactor content made from or containing the hydrocracking catalyst, gaseous reaction products, and a hydrodepolymerization product;
iv) separating the content of the reactor, thereby obtaining a liquid or liquefiable hydrodepolymerization product, the hydrocracking catalyst, or hydrogen-enriched gas fractions;
v) optionally, re-introducing the hydrocracking catalyst or hydrogen-enriched gas fractions obtained in separation step iv) into the reactor; and
vi) optionally, collecting the hydrogen-enriched gas fractions.

2. The process of claim 1, wherein the inorganic carrier of the hydrogenating component is the depolymerizing component.

3. The process of claim 1, wherein the hydrocracking catalyst is a physical mixture of a hydrogenation catalyst comprising the hydrogenating component and a depolymerization catalyst comprising the depolymerizing component.

4. The process of claim 3, wherein the inorganic carrier of the hydrogenating component has a pore volume of from 0.2 to 4 ml/g.

5. The process of claim 1, wherein the hydrocracking catalyst comprises active hydrogenation species in an amount from 0.5 to 25 wt. %, based on the total weight of the hydrocracking catalyst.

6. The process of claim 1, wherein the hydrocracking catalyst and the feedstock of organic polymeric waste material are fed into the reactor at a catalyst-to-feed (C/F) ratio of from 1:500 to 1:10.

7. The process of claim 1, wherein the hydrodepolymerization is carried out at a temperature from 200 to 550° C.

8. The process of claim 1, wherein the polymeric waste material comprises a plastic material selected from the group comprising or consisting of polyethylene (PE), polypropylene (PP), polystyrene (PS), polyethylene terephthalate (PET), polyvinylchloride (PVC), polyamide (PA), polyurethane (PU), polyacrylonitrile (PAN), polybutylene (PB), and mixtures thereof.

9. The process of claim 1, wherein the polymeric waste material has a total content of volatiles, measured as weight loss at 100° C. and a pressure of 200 mbar over a period of 2 hours, of less than 10 wt. %, based on the total weight of the polymeric waste material.

10. The process of claim 1, wherein the polymeric waste material is selected from the group consisting of a shredded polymeric waste material having a bulk density from 50 to 500 g/l and a polymeric waste material in pellet form having a bulk density from 300 to 700 g/l, wherein the bulk density being determined according to DIN 53466.

11. The process of claim 1, wherein the polymeric waste material has a polyolefin content more than 50 wt. %, based on the total weight of the polymeric waste material feedstock.

12. The process of claim 1, wherein the polymeric waste material has a total chlorine content less than 1.0 wt. % based on the total weight of the polymeric waste material.

13. The process of claim 1, wherein the hydrodepolymerization product has (a) a content of olefinic compounds; of less than 20, expressed as bromine number, based on the total weight of the hydrodepolymerization product or (b) less than 10 mol % of aromatic protons, based on 1H-NMR spectrum.

14. The process of claim 1 further comprising the steps for preparing the hydrogenating component, comprising the steps of
a) providing a precursor compound in the form of a salt for a metal selected from the group consisting of Fe, Mo, W, Ti, Ni, Cr, V, Co, Zr, and mixtures thereof;
b) dissolving the precursor compound in a polar solvent;
c) providing an inorganic carrier;
d) depositing the dissolved precursor compound on the inorganic carrier by incipient wetness impregnation, thereby obtaining a hydrogenating component precursor;
e) drying the hydrogenating component precursor;
f) treating the dried hydrogenating component precursor at a temperature from 200 to 850° C., thereby yielding a product; and
g) cooling the product of step f), thereby obtaining the hydrogenating component of the hydrocracking catalyst.

15. A process for producing olefins, comprising the steps of
i) providing a feedstock of polymeric waste material;
ii) mixing the feedstock of polymeric waste material with a hydrocracking catalyst comprising
(a) a hydrogenating component comprising a metal selected from the group consisting of Fe, Mo, W, Ti, Ni, Cr, V, Co, Zr, and mixtures thereof, supported on an inorganic carrier and
(b) a depolymerizing component being an acidic compound;
iii) introducing the mixture into a reactor and treating the mixture with hydrogen;
iv) separating the content of the reactor, thereby obtaining to obtain a liquid or liquefiable hydrodepolymerization product and gaseous fractions;
v) optionally, collecting the gaseous fractions; and
vi) introducing the hydrodepolymerization product into a steam cracker for forming a product comprising olefins.
